(19) United States
(12) Patent Application Publication
(10) Pub. No.: US 2003/0233555 A1
(43) Pub. Date: Dec. 18, 2003

(54) Secure system for smartcard transactions

(76) Inventor: Yigal Shusteri, Jerusalem (IL)

Correspondence Address: Katten Muchin Zavis Rosenman, 15th Floor, 575 Madison Avenue, New York, NY, 10022-2585, US

(21) Appl. No.: 10/221,047

(22) PCT Filed: Mar. 5, 2001
(86) PCT No.: PCT/IL01/00205

(30) Foreign Application Priority Data
Mar. 9, 2000 (IL) 134988

(51) Int. Cl. H04L 9/00

(52) U.S. Cl. 713/185

(57) ABSTRACT

A computerized system for secure user validation and transaction entry that overcomes the limitations of the prior art by disconnecting the transaction entry system from any external computer system or network not only during user validation but also during the entire process of transaction entry.

### FIELD OF THE INVENTION

The present invention relates generally to systems for secure computer and Internet access.

### BACKGROUND OF THE INVENTION

With increased use of computers to perform financial and other sensitive transactions, there is increased need for security in performing these transactions. Access to transaction programs and records is often controlled using portable devices with embedded microprocessors and non-volatile memory, such as smartcards, that are issued to authorized users. They typically include personalized information, private keying material, and a personal access code, commonly known as a Personal Identification Number (PIN). The user must enter a correct PIN to unlock the card and the system being accessed for operation. Use of such user validation systems and methods with remote computers via networks or the Internet exposes the user and associated private data or resources to risk from malicious users (“hackers”) and programs which may capture the PIN and compromise user security.

These security problems are discussed in greater detail in U.S. Pat. No. 5,406,624 issued to Tulpan and U.S. Pat. No. 5,844,497 issued to Gray which both address the specific problem of security of PIN entry, the contents of which are incorporated herein, by reference. Tulpan uses software to isolate PIN entry and verification from the computer system or network being accessed, and Gray employs a switching device to physically disconnect the user from the computer system or network during PIN entry and verification.

Neither of these solutions goes far enough in protecting the user and the user's associated data. The same sort of program that monitors remote stations from the central computer or the Internet for PIN capture could take over the user's data and simulate the user to enter false transactions after user verification has been confirmed. There is a need for greater user control of sensitive data and for more comprehensive protection from falsification or forging of user transactions even after user authorization.

### SUMMARY OF THE INVENTION

An aim of the present invention is to provide a computerized system for secure user validation and transaction entry that overcomes the limitations of the prior art by disconnecting the transaction entry system from any external computer system or network not only during user validation but also during the entire process of transaction entry.

There is thus provided, in accordance with a preferred embodiment of the invention, a secure user validation and transaction entry system, for use with an electronic information system, including:

a data carrier reader, which may be integrally connected to the system or configured as a portable unit for connection thereto, the data carrier reader being configured for accepting a data carrier, which may be a magnetic strip, a barcode, a magnetic disk, a memory chip carrier, or a smartcard, for user validation;

a manual data input device, which may be:

a keyboard associated with the electronic information system, the keyboard configured to integrally include the secure user validation and transaction entry system;

an integrally mounted keypad; or

a voice recognition device,

associated with either the data carrier reader or an electronic information system, for a user to enter validating information and transaction commands;

verifying apparatus for checking the validating information entered by the user and for conditionally generating validation response signals;

switching apparatus for selectably disconnecting the secure user validation and transaction entry system from the electronic information system;

a data processing module for processing user validation response signals and transaction commands and generating transaction command signals therefrom;

a real-time clock associated with the data processing module for providing a time stamp for system operations;

a non-volatile data storage device associated with the data processing module for storing programs and data required to process user validating information and transaction commands and preselected additional data associated with the user;

a user indication device, which may be an alpha-numeric display, a set of LEDs, or a speaker, and which may be an auxiliary device selectably associable with the electronic information system, for providing the user with sensible indications of system responses to user data input; and

control apparatus for disconnecting, via the switching apparatus and under predetermined conditions, the secure user validation and transaction entry system from the electronic information system; for checking, via the verifying apparatus, the validating information and accepting validation response signals therefrom; and for providing accepted validation response signals to the data processing module and accepting transaction command signals therefrom and transferring the accepted validation response signals and the transaction command signals to the electronic information system after the secure user validation and transaction entry system is reconnected thereto,

wherein the predetermined conditions include a user entering validating information and the verifying apparatus checking the validating information and the user entering transaction commands and the data processing module processing the transaction commands and generating transaction command signals therefrom.

Additionally in accordance with a preferred embodiment of the present invention, the non-volatile data storage device may be configured as a fixed unit integrally connected to the system or with a portable storage medium for insertion therein. It may also be configured with both fixed and portable portions, in which case, the portable portion may serve as the data carrier reader and the portable storage medium may serve as the data carrier.

In accordance with a further preferred embodiment of the present invention, the data carrier is a smartcard and the data carrier reader is a smartcard reader which includes:

a contact apparatus including a plurality of leaf spring structures each having a first end portion fabricated to engage and to retain therein a contact ball, providing electrical contact therewith, and a second end portion arranged for contact and supported in mechanical association with a connector device, which may be via a soldered bond; and

an enclosure having a slot, which may include:

a brush to prevent entry of dust and dirt into the enclosure,

a mechanical stop for properly positioning the smartcard therein, and

a gradually sloped step formed therein for minimizing friction with the smartcard during its insertion and for raising the smartcard, when fully inserted, into a position to maintain contact between the smartcard contact pads and the contact balls,

for insertion therein of a smartcard and supporting therein the contact apparatus, so that, when a smartcard is inserted therein, the contact balls are aligned with contact pads on the smartcard;

and wherein the first end portions of the leaf spring structures further provide pressure to impel the contact balls towards the contact pads on the smartcard so as to engage the contact pads with pressure and form electrical contacts therewith.

Further, the contact apparatus further includes a contact support having formed therethrough a plurality of apertures, which may be formed with a tapered portion for retaining the contact balls therein, each containing one of the contact balls seated protrudingly in its respective aperture with pressure provided by the leaf spring structures and each aligned with a contact pad on the smartcard, when it is inserted into the enclosure, so that the contact balls, as they protrude from the apertures, engage the contact pads and form electrical contacts therewith. The leaf spring structures and the contact balls, which may be gold plated, maintain vibration-resistant contact between the contact balls and their respective contact pads on the smartcard.

Additionally in accordance with a preferred embodiment of the present invention, the contact apparatus includes an additional contact operable to cause an electrical short indicating insertion of a smartcard, in accordance with international standard ISO 7816-123.

In accordance with a further embodiment of the present invention, the secure system further includes, a remote communications device for communication with the electronic information system, which may be a mobile communications device such as a mobile telephone.

There is further provided, in accordance with a preferred embodiment of the present invention, a method of securely entering electronic transactions employing the above-mentioned secure user validation and transaction entry system including the following steps:

detecting insertion of a data carrier into a data carrier reader;

prompting the user, via a user indication device, to enter validating information via a data input device;

prior to accepting validating information, disconnecting the user interface device from the electronic information system;

accepting and checking user validating information immediately after the step of disconnecting;

conditionally generating validation response signals;

providing a user sensible output indication to the user, via the user indication device, indicating the result of checking the validating information;

further prompting the user, in the case of successful validation thereof, to enter transaction commands;

accepting transaction commands from the user;

processing the transaction commands and generating therefrom transaction command signals;

reconnecting the user interface device to the electronic information system; and

providing the validation response signals and transaction command signals to the electronic information system.

### BRIEF DESCRIPTION OF THE DRAWINGS

The present invention will be more fully understood and appreciated from the following detailed description, taken in conjunction with the drawings, in which:

FIG. 1 is a high-level block diagram of a secure user validation and transaction entry system, constructed and operative in accordance with a preferred embodiment of the present invention;

FIG. 2 is an exploded view of a smartcard interface, constructed and operative in accordance with a preferred embodiment of the present invention;

FIG. 3A is an underside view of the bridge of the smartcard interface of the present invention;

FIG. 3B is a side view, taken in the direction of arrows B in FIG. 3A, of the bridge of the smartcard interface of FIG. 3A;

FIG. 4 is an enlarged detailed view of a tapered aperture formed in the bridge of the smartcard interface of FIGS. 3A and 3B;

FIG. 5 is a detailed view of a portion of a smartcard interface, constructed and operative in accordance with a further preferred embodiment of the present invention;

FIG. 6 is the leaf spring structure of the smartcard interface of FIG. 5, shown in enlarged side and transverse views; and

FIG. 7 is a block diagram of a secure user validation and transaction entry system, constructed and operative in accordance with an alternative preferred embodiment of the present invention.

### DETAILED DESCRIPTION OF THE INVENTION

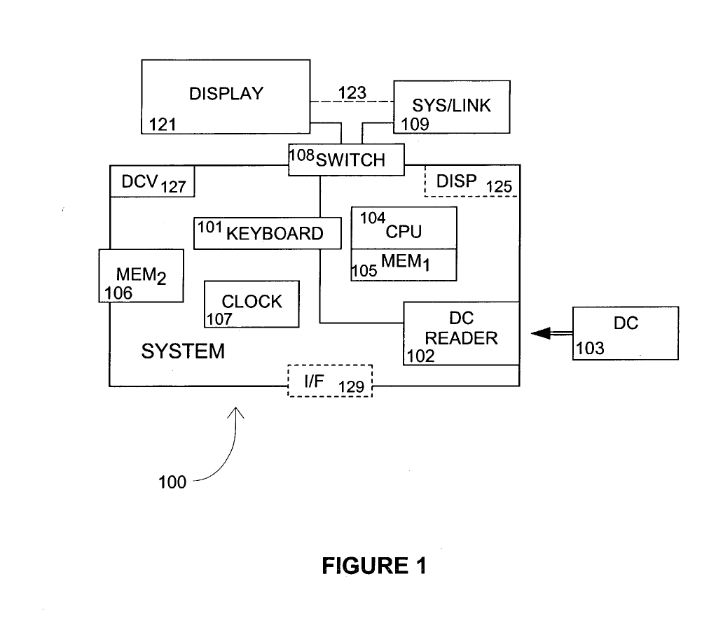

Referring now to FIG. 1, there is shown a block diagram of a secure user validation and transaction entry system referred to generally as 100, constructed and operative in accordance with a preferred embodiment of the present invention. Secure system 100 includes a power source 127 to supply DC voltage (DCV) to the system, a keyboard 101 for user data entry, a data carrier (DC) reader 102 for accepting and reading a data carrier 103 such as a smartcard for user validation, a data processing module 104 for processing user inputs and controlling operation of secure system 100, one data storage device 105 associated with data processing module 104 and containing system data and programs, a second data storage device 106 for storing user data in addition to user validation data stored on data carrier 103, a real-time clock 107 for providing a time signature to all system operations to protect against forged transactions, and a switching device 108 for disconnecting secure system 100, under control of data processing module 104, from the electronic information system 109 the user wishes to access.

Electronic information system 109 may be accessed directly or remotely, possibly via a network such as the Internet, using a linking or communication device such as a modem. A common example of an application using a network is an automatic teller machine (ATM) for remote banking. It should be noted that in the following description, electronic information system 109 is used to refer either to an independent electronic information system or to a linking or communication device which communicates directly or via a network with a remote electronic information system. Typically, electronic information system 109 has associated therewith a display device 121 for communication with the user. If data processing module 104 of secure system 100 uses the same display 121 for its user communication, then switching device 108 must also control the connection to display 121, as shown by the solid line therebetween in the drawing. Alternatively, display 121 may be directly connected with electronic information system 109, as indicated by broken line 123 therebetween in the drawing; and secure system 100 further includes an additional display device 125 (broken line box in the drawing) for communication with the user when isolated from display 121. Display device 125 may be a set of user indicator lights, such as LEDs, or an alphanumeric display. In an alternative embodiment of the present invention, user communication may be performed by voice message generation and a speaker.

In a preferred embodiment of the present invention, secure system 100 is integrally configured with keyboard 101 which is associated with electronic information system 109 or the linking device connected thereto. Alternatively, a standard or dedicated keypad connected to secure system 100 may be used. In a further alternative embodiment, user input may be via voice recognition apparatus.

In a further alternative embodiment of the present invention, secure system 100 has integrally configured therewith an interface 129, which may be a computer bus, such as USB, which also allows linkage to an external device, or a local area network (LAN), such as an ethernet, which may link, via an IEEE-1394 standard (firewire) connection to a DSL, cellular, cable, satellite, or other suitable modem. This linkage may be, in an alternative embodiment of the present invention, via switching device 108, rather than as shown in the drawing. In such configurations, secure system 100 may function as a “network computer,” wherein data processing module 104 and its associated data storage device 105 only require the capabilities to perform the security functions described herein and to mediate connection with an external information system 109 or network.

Data carrier reader 102 and associated data carrier 103 allow user validation before access is granted to user data and electronic information system 109. Typically, the user inserts data carrier 103 into data carrier reader 102 and is prompted to enter a personal access code, commonly known as a Personal Identification Number (PIN), which is encoded on data carrier 103. There are many data carrier technologies which may be used, including magnetic strips, barcodes, magnetic disks, and memory chip carriers. A common memory chip carrier is the smartcard, but others are available, such as coin-shaped chip carriers. Most smartcards or other chip carriers are read by direct contact with contact pads thereon, but in this case as well, other technologies may be used, such as RF transmission between carrier and reader. In accordance with further alternative embodiments of the present invention, data carrier reader 102 may be integrally configured with secure system 100; or it may be a portable unit, configured to be connected to secure system 100 once data carrier 103 is inserted therein. For example, data carrier reader 102 may be configured as part of a wrist-mounted unit such as a calculator wristwatch, which, as is known, has both a display and a keypad, and which may be linked to secure system 100 via a wired or wireless connection. In an alternative embodiment of the present invention, secure system 100 itself is configured as part of the wrist-mounted unit, together with data carrier reader 102, a keypad, display, and linkage, wired or wireless, with electronic information system 109. It should be noted, however, that the present invention is by no means limited to a particular configuration such as the calculator wristwatch described hereinabove, which is given strictly by way of example.

Data processing module 104 with associated data storage device 105 manages all interaction between secure system 100 and the user and user data storage device 106. Once the user inserts data carrier 103 into data carrier reader 102 and is prompted to enter a personal access code or PIN, data processing module 104 directs switching device 108 to disconnect secure system 100, including in particular keyboard 101 and possibly, as described hereinabove, display 121, for user validation. Such a system is taught by Gray in U.S. Pat. No. 5,844,497, the contents of which is incorporated herein by reference. As opposed to the prior art, however, in which the user is reconnected to the electronic information system 109 after validation, in the present invention, data processing module 104, which, it should be emphasized, is not accessible by remote networks, per se, but is entirely local to secure system 100, accepts and processes all user transaction commands while secure system 100 is still disconnected from electronic information system 109. A session of user transactions typically requires interaction or dialog between the user and the system; hence, secure system 100 includes additional display device 125 or secure connection via switching device 108 with display 121 associated with electronic information system 109 as described above.

In accordance with a preferred embodiment of the present invention, data processing module 104 and its associated data storage device 105 includes and is able to run all the programs required to manage the user transaction session. User data, typically required as well, is stored on a separate user data storage device 106, which may be revised during the session. In a preferred embodiment of the present invention, user data storage device 106 is a non-volatile, portable medium, such as a diskette, a zip disk, or a memory card, with a suitable interface or reader, which the user will insert into secure system 100 in addition to data carrier 103. In an alternative embodiment of the present invention, a portable user data storage device 106 may also serve as data carrier 103.

Once the user has completed all transactions and user data on user data storage device 106 has been updated accordingly, data processing module 104 will convert the session of transaction commands into a secure, and possibly compressed format for transmission to electronic information system 109. Only then will data processing module 104 direct switching device 108 to reconnect secure system 100 to electronic information system 109 for the transmission.

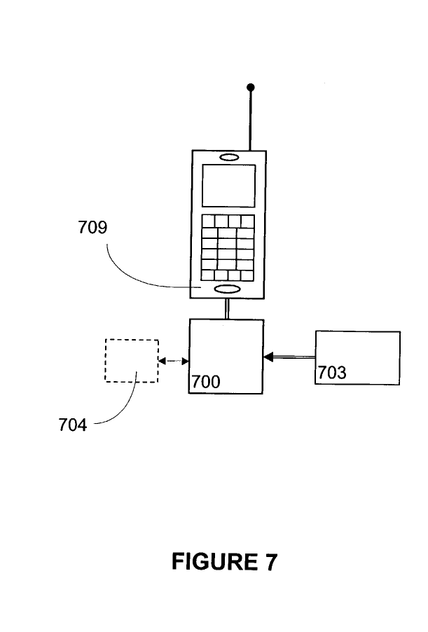

Referring briefly to FIG. 7, there is shown a block diagram of a secure user validation and transaction entry system 700, constructed and operative in accordance with an alternative preferred embodiment of the present invention, employing a mobile telephone 709, such as a cellular or satellite telephone, to communicate with a remote electronic information system. Secure system 700, substantially as described hereinabove in conjunction with FIG. 1, includes a data carrier reader for accepting and reading a data carrier 703, such as a smartcard, for user validation. In the present embodiment, the data processing module and the associated data storage device required to perform the security functions described hereinabove and to mediate communication with mobile telephone 709 for connection with the remote electronic information system are all contained within and performed by secure system 700. In an alternative embodiment of the present invention, secure system 700 connects to a local electronic information system 704, which may be only a network computer as described hereinabove or may have additional capabilities, and which performs the above-mentioned functions.

In accordance with a further preferred embodiment of the present invention there is a method of securely entering electronic transactions via a user interface device connected to an electronic information system and having associated therewith a data carrier reader, a data input device, and a user indication device as described hereinabove.

Referring again briefly to FIG. 1, in accordance with a preferred embodiment of the present invention, data carrier 103 is a smartcard and data carrier reader 102 is a smartcard reader.

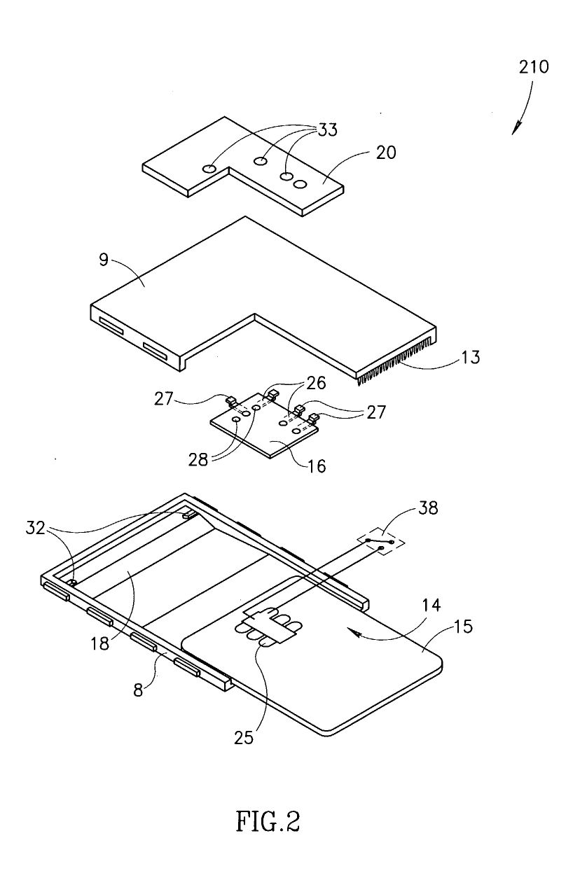

Referring now to FIGS. 2 through 4, there is shown a smartcard interface referred to generally as 210, constructed and operative in accordance with a preferred embodiment of the present invention.

Referring now to FIG. 2, there is shown an exploded view of the smartcard interface 210 of the present embodiment of the invention. Smartcard interface 210 has a lower portion 8 which engages upper portion 9 to form an enclosure with a slot 14 which allows sliding insertion of smartcard 15. Slot 14 is provided with a brush 13 to prevent dirt and dust from entering the interface interior. Upper portion 9 accommodates a bridge 16 which supports contact balls 28 to make contact with contact pads 25 on smartcard 15 when it is fully inserted into smartcard interface 210. Bridge 16 also has leaf springs 26 which engage contact balls 28 and have contact portions 27 extending therefrom. When bridge 16 is installed in smartcard interface 210, contact portions 27 of leaf springs 26 engage contact pads 33 on printed circuit board (PCB) 20, which is mounted on the outer side of upper portion 9 of smartcard interface 210, forming a good electrical contact therebetween. PCB 20 is typically provided with integrated circuits and electrical components which connect externally to an electronic system via suitable electrical connectors, which may be mounted on smartcard interface 210.

Lower portion 8 of smartcard interface 210 has a sloped step 18 formed thereon and stops 32 to ensure proper insertion of smartcard 15. The shape of lower portion 8 and slot 14 formed when upper portion 9 engages therewith directs insertion of smartcard 15 at an angle so that its upper surface, in particular contact pads 25, initially do not engage contact balls 28 as smartcard 15 is being inserted. As full insertion via slot 14 is approached, the slope of step 18 lifts smartcard 15 to engage contact balls 28 on bridge 16 with smartcard contact pads 25, forming a good electrical connection therebetween. Stops 32 define full insertion of smartcard 15 and ensure proper alignment of contact balls 28 with smartcard contact pads 25. Contact pads 33 and 25, leaf springs 26, and contact balls 28 are typically fabricated of or plated with gold to enhance the quality of the electrical contacts formed therebetween. Also indicated schematically by 38 in FIG. 2 are switching contacts used to make an electrical short, which completes the connection to smartcard contact pads 25 on smartcard 15. By this electrical short PCB 20 receives an indication signal that smartcard 15 has been inserted into smartcard interface 210, as per international standard ISO 7816-123.

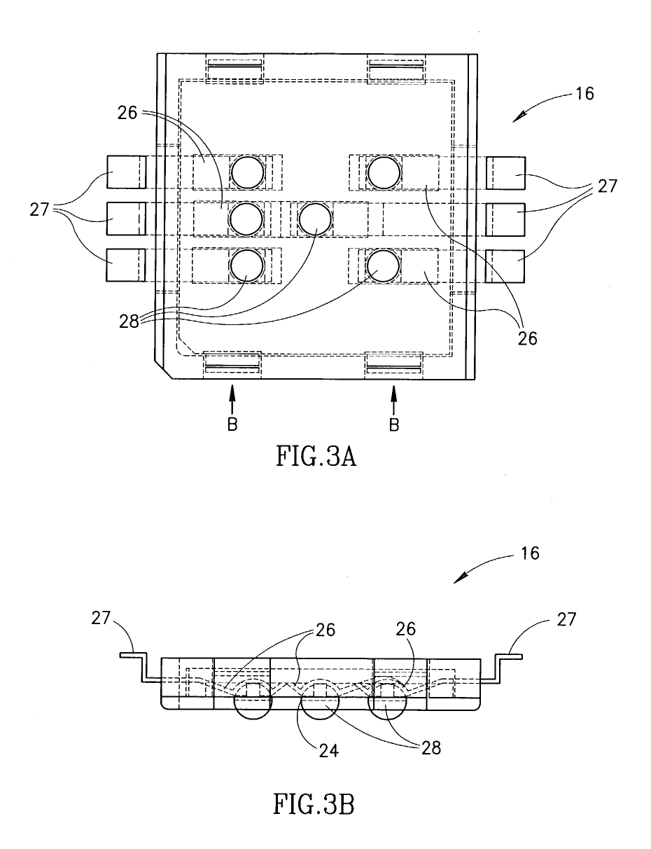

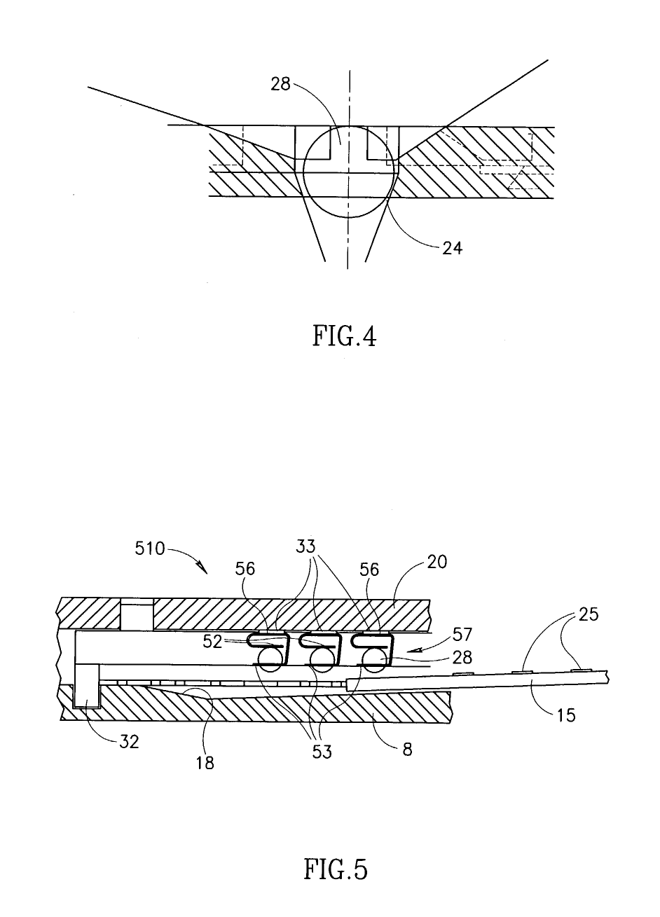

FIGS. 3A and 3B show underside and side views, respectively, of bridge 16. FIG. 3A shows a typical arrangement of contact balls 28 for contacting the contact pads on a smartcard. Shown in broken lines are leaf springs 26 which are in good electrical contact with balls 28 and which provide a downward force, in the orientation of the present embodiment, thereto, so that balls 28 extend through apertures 24. This is seen clearly in the side view of FIG. 3B, taken in the direction of arrows B in FIG. 3A, which shows how leaf springs 26 are contoured to engage balls 28. Each leaf spring 26 extends outward and upward from bridge 16, ending in a contact portion 27 which engages a contact pad 33 on PCB 20 (FIG. 2), forming a good electrical connection thereto when bridge 16 is installed in smartcard interface 210. Apertures 24 have a tapered opening to allow maximum protrusion of contact balls 28 from the lower face of bridge 16 while retaining contact balls 28 therewithin, as shown in FIG. 4, an enlarged detailed view of a tapered aperture 24 on bridge 16.

Referring now to FIG. 5, there is shown a portion of a smartcard interface, referred to generally as 510, constructed and operative in accordance with a further preferred embodiment of the present invention. Smartcard interface 510 has a lower portion 8 similar to that of smartcard interface 210 of the previous embodiment shown in FIGS. 2-4, with a step 16 and stops 32 that function as described hereinabove. FIG. 5 clearly shows the function of step 18: Smartcard 15 does not touch contact balls 28 as it is inserted onto smartcard interface 510 until sloping step 18 raises it at the end of its insertion before coming against stops 32.

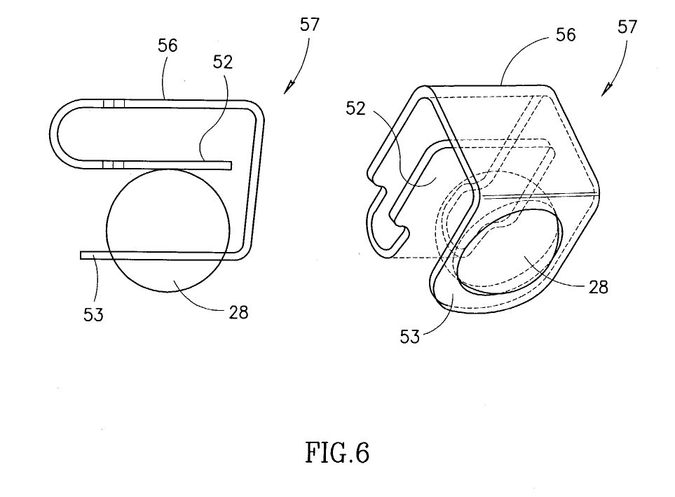

The present embodiment employs contact balls 28 which are supported by leaf spring structures 57, which are shown in detail in FIG. 6. Each leaf spring structure 57 has a lower portion with a hole branch 53 which supports and contains a contact ball 28 and a spring branch 52 which exerts a force thereon to ensure good electrical contact between contacts balls 28 and smartcard contact pads 25 on smartcard 15 when it is fully inserted into smartcard interface 510. Each leaf spring structure 57 also has an upper portion 56 which engages a contact pad 33 on PCB 20. In the present embodiment, upper portions 56 of spring structures 57 are soldered onto contacts pads 33 on PCB 20. As in the previously described embodiment, contact pads 33 and 25, leaf spring structures 57, and contact balls 28 are typically fabricated of or plated with gold to enhance the quality of the electrical contacts formed therebetween. In an alternative embodiment of the present invention, smartcard interface 510 includes a bridge (not shown), similar to that in the embodiment shown in FIGS. 2-4 and described hereinabove, which support and position spring structures 57 in good electrical contact with contact pads 33 of PCB 20 and, when smartcard 15 is inserted into smartcard interface 510, with smartcard contact pads 25 on smartcard 15.

It will further be appreciated by persons skilled in the art that the scope of the present invention is not limited by what has been specifically shown and described hereinabove, merely by way of example. Rather, the scope of the present invention is defined solely by the claims, which follow.

What is claimed is:

1. For use with an electronic information system, a secure user validation and transaction entry system including:
a data carrier reader configured for accepting a data carrier for user validation;
a manual data input device, associated with at least one of said data carrier reader and an electronic information system, for a user to enter validating information and transaction commands;
verifying apparatus for checking the validating information entered by the user and for conditionally generating validation response signals;
switching apparatus for selectably disconnecting said secure user validation and transaction entry system from the electronic information system;
a data processing module for processing user validation response signals and transaction commands and generating transaction command signals therefrom;
a real-time clock associated with said data processing module for providing a time stamp for system operations;
a non-volatile data storage device associated with said data processing module for storing:
programs and data required to process user validating information and transaction commands, and
preselected additional data associated with the user;
a user indication device for providing the user with sensible indications of system responses to user data input; and
control apparatus for disconnecting, via said switching apparatus and under predetermined conditions, said secure user validation and transaction entry system from the electronic information system; for checking, via said verifying apparatus, the validating information and accepting validation response signals therefrom; and for providing accepted validation response signals to said data processing module and accepting transaction command signals therefrom and transferring the accepted validation response signals and the transaction command signals to the electronic information system after said secure user validation and transaction entry system is reconnected thereto;
wherein said predetermined conditions include a user entering validating information and said verifying apparatus checking the validating information and the user entering transaction commands and said data processing module processing the transaction commands and generating transaction command signals therefrom.

2. A secure user validation and transaction entry system according to claim 1, wherein said data carrier reader is configured as a fixed unit integrally connected thereto, for insertion therein of a data carrier.

3. A secure user validation and transaction entry system according to claim 1, wherein said data carrier reader is configured as a portable unit for connection thereto, once a data carrier is inserted therein.

4. A secure user validation and transaction entry system according to claim 1, wherein said data carrier is one of a group consisting of:
a magnetic strip,
a barcode,
a magnetic disk,
a memory chip carrier, and
a smartcard;
and wherein said data carrier reader is a reader device operative to read data from said data carrier.

5. A secure user validation and transaction entry system according to claim 1, wherein said data carrier reader is a smartcard interface and said data carrier is a smartcard.

6. A secure user validation and transaction entry system according to claim 5, wherein said smartcard interface includes:
contact apparatus including a plurality of leaf spring structures each having a first end portion fabricated to engage a contact ball providing electrical contact therewith and a second end portion arranged for contact with a connector device; and
an enclosure having a slot for insertion therein of a smartcard and supporting therein said contact apparatus, so that, when a smartcard is inserted therein, said contact balls are aligned with contact pads on the smartcard;
and wherein said first end portions of said leaf spring structures further provide pressure to impel said contact balls towards the contact pads on the smartcard so as to engage the contact pads with pressure and form electrical contacts therewith.

7. A secure user validation and transaction entry system according to claim 6, wherein said contact apparatus further includes a contact support having formed therethrough a plurality of apertures each containing one of said contact balls,
wherein said leaf spring structures further provide pressure to seat said contact ball with pressure protrudingly in its respective aperture;
and wherein, when a smartcard is inserted into said enclosure, said apertures are aligned with the contact pads on the smartcard and said contact balls protrude from said apertures to engage the contact pads and form electrical contacts therewith.

8. A secure user validation and transaction entry system according to claim 6, wherein each said second end portion of said leaf spring structures is supported in mechanical association with said connector device at a predetermined location and wherein each said first end portion of said leaf spring structures is fabricated to retain its respective contact ball therein.

9. A secure user validation and transaction entry system according to claim 8, wherein said second end portions of said leaf spring structures are bonded by soldering to said connector device.

10. A secure user validation and transaction entry system according to claim 6, wherein said leaf spring structures and said contact balls are operable to maintain vibration-resistant contact between said contact balls and their respective contact pads on the smartcard.

11. A secure user validation and transaction entry system according to claim 7, wherein said apertures are formed with a tapered portion for retaining said contact balls therein.

12. A secure user validation and transaction entry system according to claim 6, wherein said enclosure has formed thereon a mechanical stop for properly positioning the smartcard therein.

13. A secure user validation and transaction entry system according to claim 6, wherein said enclosure has formed therein a gradually sloped step for minimizing friction with the smartcard during its insertion and for raising the smartcard, when fully inserted, into a position to maintain contact between the smartcard contact pads and said contact balls.

14. A secure user validation and transaction entry system according to claim 6, wherein said contact apparatus includes an additional contact operable to cause an electrical short indicating insertion of a smartcard.

15. A secure user validation and transaction entry system according to claim 6, wherein said slot includes a brush preventing entry of dust and dirt into said enclosure.

16. A secure user validation and transaction entry system according to claim 6, wherein said contact balls and said leaf spring structures are gold-plated.

17. A secure user validation and transaction entry system according to claim 1, wherein said manual data input device is a keyboard associated with the electronic information system.

18. A secure user validation and transaction entry system according to claim 17, wherein said keyboard includes said secure user validation and transaction entry system integrally mounted thereon.

19. A secure user validation and transaction entry system according to claim 1, wherein said manual data input device is a keypad integrally mounted thereon.

20. A secure user validation and transaction entry system according to claim 1, wherein said manual data input device is a voice recognition device.

21. A secure user validation and transaction entry system according to claim 1, wherein said user indication device is at least one of an alpha-numeric display, a set of LEDs, and a speaker.

22. A secure user validation and transaction entry system according to claim 1, wherein said non-volatile data storage device is configured as a fixed unit integrally connected thereto.

23. A secure user validation and transaction entry system according to claim 1, wherein said non-volatile data storage device is configured with a portable storage medium for insertion therein.

24. A secure user validation and transaction entry system according to claim 1, wherein said non-volatile data storage device is configured with a fixed portion integrally connected to said secure user validation and transaction entry system and a portable portion having a portable storage medium for insertion therein.

25. A secure user validation and transaction entry system according to claim 24, wherein said portable portion of said non-volatile data storage device serves as said data carrier reader and said portable storage medium serves as said data carrier.

26. A secure user validation and transaction entry system according to claim 1, wherein said user indication device is an auxiliary device selectably associable with the electronic information system.

27. A secure user validation and transaction entry system according to claim 1, further including a remote communications device for communication with the electronic information system.

28. A secure user validation and transaction entry system according to claim 27, wherein said remote communications device is a mobile communications device.

29. A secure user validation and transaction entry system according to claim 28, wherein said mobile communications device is a mobile telephone.

30. A method of securely entering electronic transactions via a user interface device connected to an electronic information system and having associated therewith a data carrier reader, a data input device, and a user indication device, including the following steps:
detecting insertion of a data carrier into a data carrier reader;
prompting the user, via a user indication device, to enter validating information via a data input device;
prior to accepting validating information, disconnecting the user interface device from the electronic information system;
accepting and checking user validating information immediately after said step of disconnecting;
conditionally generating validation response signals;
providing a user sensible output indication to the user, via the user indication device, indicating the result of checking the validating information;
further prompting the user, in the case of successful validation thereof, to enter transaction commands;
accepting transaction commands from the user;
processing the transaction commands and generating therefrom transaction command signals;
reconnecting the user interface device to the electronic information system; and
providing the validation response signals and transaction command signals to the electronic information system.
